(19) United States
(12) Patent Application Publication
(10) Pub. No.: US 2021/0269289 A1
(43) Pub. Date: Sep. 2, 2021

(54) CRANE

(71) Applicant: KOBELCO CONSTRUCTION MACHINERY CO., LTD., Hiroshima-shi (JP)

(72) Inventors: Naoya KITAZUMI, Hyogo (JP); Yuudai MOTOYAMA, Hyogo (JP)

(73) Assignee: KOBELCO CONSTRUCTION MACHINERY CO., LTD., Hiroshima-shi (JP)

(21) Appl. No.: 17/258,615

(22) PCT Filed: Jul. 19, 2019
(86) PCT No.: PCT/JP2019/028382

§ 371 Date: Jan. 7, 2021

(30) Foreign Application Priority Data
Aug. 1, 2018 (JP) 2018-145197

(51) Int. Cl. B66C 23/76; B66C 23/44

(52) U.S. Cl. CPC B66C 23/76; B66C 2700/0364; B66C 23/44

(57) ABSTRACT

To suppress rotation of a cylinder rod relative to a cylinder body while avoiding interference of a weight cylinder connecting a distal end of a mast to a weight guy line with other members in assembling and disassembling. The crane includes a pair of right and left weight cylinders having a cylinder body and a cylinder rod, and a pair of right and left mast cylinder connecting portions. The pair of right and left mast cylinder connecting portions regulate the rotation of the cylinder rod and connect the right and left both side parts of the mast and the pair of right and left cylinder rods to each other.

### TECHNICAL FIELD

The present invention relates to a crane.

### BACKGROUND ART

Conventionally, a crane having a crane body, a boom, a mast, and a pair of right and left mast guy lines has been known. The boom is mounted on the front part of the crane body in a derricking manner around a horizontal rotation axis. The mast is provided in a derricking manner on the crane body around a rotation axis parallel to the rotation axis of the boom at the rear of the boom, and functions as a support in derricking the boom. When the crane is used, the boom is inclined forward and the mast is inclined backward. At this time, in order to maintain the posture of the mast, a pair of right and left mast guy lines are arranged between the distal end of the mast and the crane body in a state where tension is applied to the pair of mast guy links.

Patent Document 1 discloses a crane having a weight disposed behind the crane body. The weight is supported by a pair of right and left weight guy links (weight guy lines) suspended from the distal end of the mast. A lower end portion of the weight guy link is provided with 1 plate-shaped portion (male shaped portion), and an upper surface portion of the weight is provided with 2 plate-shaped portions (female shaped portion). A hole part is opened in each plate part along the horizontal direction, and when the hole part of the male shaped portion is matched with the hole part of the female shaped portion and a connecting pin is inserted into both hole parts, a weight guy link is connected to the weight.

Further, in this technology, the crane is provided with a pair of right and left expandable hydraulic cylinders (weight cylinder) for respectively connecting the distal end of the mast and a pair of right and left weight guy links. The hydraulic cylinder includes a cylinder body connected to the distal end of the mast, and a cylinder rod extending downward from the cylinder body and capable of expanding and contracting with respect to the cylinder body. The cylinder rod is connected to the upper end of the weight guy link. When the cylinder rod of the hydraulic cylinder contracts, the weight floats upward from the ground through the weight guy link, and the balance of the crane can be maintained.

Further, in the technique, in order to prevent a pair of right and left cylinder rods from rotating around an axis extending in the vertical direction with respect to the cylinder body, the crane includes a connecting member for connecting the pair of right and left cylinder rods to each other. Since the rotation of the cylinder rods is prevented by the connecting member, the connecting parts having male and female shapes respectively arranged at the lower end of the weight guy links and the weight can be easily connected to each other.

### CITATION LIST

### Patent Literature

[Patent Document 1] Japanese Patent Publication No. 5368294

In the technique disclosed in Patent Document 1, there is a problem that the weight cylinder and surrounding members may interfere with each other when the crane is assembled and disassembled. In order to avoid such interference, it is necessary to remove the connecting member from the pair of right and left cylinder rods or to separate a part of the connecting member at the time of assembling and disassembling the crane, and the arrangement and the rotating range of the mast guy lines are greatly limited.

Specifically, the mast is in a posture (backward tilting posture) extending obliquely backward from the crane body during normal operation of the crane. On the other hand, in the disassembling work of the crane, the mast is rotated forward from the backward tilting posture, and then is fallen down (falling posture). At this time, the pair of weight cylinders including the cylinder rods connected to each other by the connecting member are placed on the mast while rotating forward with the distal end of the mast as a fulcrum. On the other hand, the pair of right and left mast guy lines are arranged between the distal end of the mast and the crane body. A pair of right and left mast guy lines are arranged inside a pair of right and left weight guy links (weight cylinders) in the right and left direction in order to minimize the width in the right and left direction of the crane body. However, when a pair of right and left cylinder rods are connected to each other by the connecting member as in the technique described in Patent Document 1, there is a possibility that the connecting member interferes with the mast guy lines when the mast rotates. Therefore, in order to avoid interference with the connecting member, the arrangement and the rotating range of the mast guy lines are restricted.

Further, a boom derricking rope for derricking the boom is arranged on the back surface (rear surface) of the mast in the working posture of the crane. The boom derricking rope is supported by an idler sheave arranged at the center of the rear surface of the mast in the right and left direction. Therefore, since the boom derricking rope supported by the idler sheave is also located between the pair of right and left weight guy links, there is a possibility that the boom derricking rope interferes with the connecting member when the mast is rotated or the crane is assembled and disassembled. In this case, in order to avoid such interference, it is necessary to remove the connecting member from the pair of right and left cylinder rods or to separate a part of the connecting member during assembly and disassembly.

### SUMMARY OF INVENTION

An object of the present invention is to provide a crane capable of suppressing relative rotation of each of cylinder rods of a pair of weight cylinders with respect to each of cylinder bodies while avoiding interference between the pair of right and left weight cylinders connecting the distal end of a mast and a pair of weight guy lines and other members when assembling and disassembling the crane.

The present invention provides a crane including: a crane body; a boom rotatably supported on the crane body about a horizontal rotation axis; a mast having a mast base end rotatably supported on the crane body about a mast rotation axis parallel to the rotation axis of the boom at a position on the rear side of the boom, and a mast distal end opposite to the mast base end, and functioning as a support in the rotation of the boom in a backward tilting posture extending backward and upward from the crane body; a pair of right and left weight cylinders respectively suspended from both right and left ends of the mast distal end and expandable and contractible in a cylinder expanding and contracting direction parallel to the direction of the suspension, the pair of right and left weight cylinders each having a cylindrical cylinder body connected to the mast distal end and a cylinder rod extending downward from the cylinder body and connected to the cylinder body so as to be relatively displaceable in the cylinder expanding and contracting direction with respect to the cylinder body; a pair of right and left weight guy lines suspended from the cylinder rod of the weight cylinder, the pair of right and left weight guy lines each having a guy line upper end portion connected to the cylinder rod and a guy line lower end portion; a weight which is connected to the guy line lower end portions of the pair of right and left weight guy lines, respectively, and holds the balance of the crane body; and a pair of right and left mast cylinder connecting portions respectively connecting the right and left side portions of the mast and the pair of right and left cylinder rods at positions closer to the mast base end than the mast distal end so as to restrict relative rotation of the cylinder rod relative to the cylinder body about the center axis of the cylinder body while permitting relative displacement of the cylinder rod relative to the cylinder body in the cylinder expanding and contracting direction.

### BRIEF DESCRIPTION OF DRAWINGS

FIG. 1 is a side view of a crane according to a first embodiment of the present invention.

FIG. 2 is a rear view of a mast and weight guy line of a crane according to the first embodiment of the present invention.

FIG. 3 is an enlarged side view of the periphery of the mast distal end, the weight cylinder, and the mast cylinder connecting portion of the crane according to the first embodiment of the present invention.

FIG. 4 is a side view of a mast cylinder connecting portion of a crane according to a second embodiment of the invention.

FIG. 5 is an enlarged side view of the periphery of the mast distal end, the weight cylinder, and the mast cylinder connecting portion of the crane according to a third embodiment of the present invention.

FIG. 6 is an enlarged side view of the periphery of the mast tip portion, the weight cylinder, and the mast cylinder connecting portion of the crane according to a fourth embodiment of the present invention.

FIG. 7A is an enlarged bottom view of the periphery of the mast cylinder connecting portion of the crane according to the fourth embodiment of the present invention.

FIG. 7B is an enlarged bottom view of the periphery of the mast cylinder connecting portion of the crane according to the fourth embodiment of the present invention.

FIG. 8 is an enlarged side view of the periphery of the mast distal end, the weight cylinder, and the mast cylinder connecting portion of the crane according to a fifth embodiment of the present invention.

FIG. 9 is an enlarged side view of the periphery of mast distal end, weight cylinder and rod connection of an other crane compared to cranes according to each embodiments of the present invention.

FIG. 10 is a side view showing the mast of the crane being rotated.

FIG. 11 is a side view showing the mast of the crane being rotated.

FIG. 12 is a side view showing the mast of the crane in a falling state.

### DESCRIPTION OF EMBODIMENTS

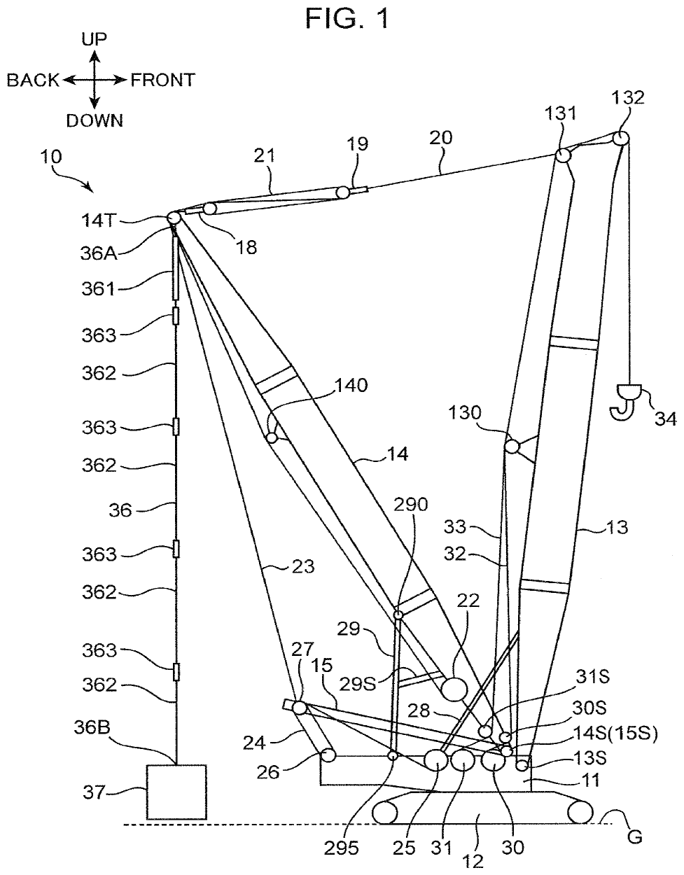

Hereinafter, a first embodiment of the present invention will be described with reference to the drawings. FIG. 1 is a side view of a crane 10 according to the present embodiment. Although the directions of “up”, “down”, “left”, “right”, “front” and “back” are shown in the drawings, the directions are shown for convenience in explaining the structure and assembling method of the crane 10 according to the present embodiment, and are not intended to limit the moving direction and the mode of use of the crane according to the present invention.

The crane 10 includes a turning body 11 corresponding to a crane body, a traveling body 12 rotatably supporting the turning body 11, a boom 13 as a derricking member, an HL (Heavy Lifting) mast 14 (mast) as a boom derricking member, and a box mast 15.

The boom 13 shown in FIG. 1 is supported on a front portion of the turning body 11 so as to be rotatable in a derricking direction around a horizontal rotation axis. The boom 13 includes a boom foot 13S. The boom foot 13S serves as a fulcrum in the rotation of the boom 13. The boom foot 13S forms a horizontal rotation axis extending in the right and left direction (lateral direction).

The boom 13 also has boom guide sheaves 130, 131, 132. The boom guide sheave 130 is disposed on the rear side surface of the longitudinal center of the boom 13. The boom guide sheaves 131 and 132 are rotatably supported at the distal end of the boom 13, respectively.

On the base end side of the boom 13, a pair of right and left boom backstops 28 are provided. These boom backstops 28 abut on the turning body 11 when the boom 13 reaches the standing posture shown in FIG. 1. By this contact, it is regulated that the boom 13 is flapped backward by strong wind or the like.

The HL mast 14 (mast) has a base end portion (mast proximal end) rotatably supported by the turning body 11 around a rotation axis (mast rotation axis) parallel to the rotation axis of the boom 13 at a position on the rear side of the boom 13, and a distal end portion (mast distal end) opposite to the base end portion. That is, the HL mast 14 is also rotatable in the same direction as the derricking direction of the boom 13. The mast 14 includes an HL mast foot 14S. The HL mast foot 14S forms the aforementioned rotation axis extending in the right and left direction (lateral direction). As shown in FIG. 1, the HL mast 14 functions as a support in the rotation of the boom 13 in a backward tilting posture extending backward and upward obliquely from the turning body 11. In other embodiments, the mast of the present invention illustrated by the HL mast 14 may be of other configurations, such as a box shaped mast. The HL mast 14 includes a mast idler sheave 140 and a mast distal sheave 14T (idler sheave). The mast idler sheave 140 is disposed on the rear side surface of the longitudinal center of the HL mast 14. The mast distal sheave 14T is rotatably supported on the mast distal end of the HL mast 14 around a rotation axis parallel to the rotation axis of the HL mast 14. The mast distal sheave 14T is disposed between the pair of right and left weight cylinders 361 described later in the right and left direction of the mast distal end. More specifically, the mast distal sheave 14T is disposed at the center of the mast distal end in the right and left direction.

On the base end side of the HL mast 14, a pair of right and left mast backstops 29 are provided. These mast backstops 29 extend from the HL mast 14 in the backward tilting posture shown in FIG. 1 (standing posture) at a position on the rear side of the rotation axis (HL mast foot 14S) of the HL mast 14 and abut on a receiving portion (not shown) arranged on the turning body 11, thereby preventing the HL mast 14 from falling backward due to strong wind or the like. The mast backstop 29 is supported by a mast backstop support portion 29S (FIG. 1) disposed on the rear side surface of the HL mast 14.

The pair of right and left mast backstops 29 respectively have a backstop upper end portion 290 and a backstop lower end portion 295. The backstop upper end portion 290, as shown in FIG. 1, is connected to the HL mast 14. The backstop lower end portion 295 abuts on the receiving portion (not shown) arranged on the turning body 11. The mast backstop 29 is rotatably supported by the HL mast 14 about a horizontal rotation axis with a backstop upper end portion 290 as a fulcrum.

The box mast 15 is rotatably connected to the turning body 11 at the rear side (downward) of the HL mast 14. The box mast 15 has a rectangular shape in cross section. The rotation axis of the box mast 15 is arranged in parallel with the rotation axis of the boom 13 and at substantially the same position as the rotation axis of the HL mast 14. That is, the box mast 15 is also rotatable in the same direction as the derricking direction of the boom 13. The box mast 15 includes a box mast foot 15S. The box mast foot 15S forms a rotation axis extending in the right and left direction (lateral direction), and serves as a fulcrum in the rotation of the box mast 15.

The crane 10 further includes a lower spreader 18, an upper spreader 19, a pair of right and left guy lines 20, a boom derricking rope 21, and a boom derricking winch 22.

The lower spreader 18 is supported at the distal end of the HL mast 14. The lower spreader 18 includes a lower sheave block not shown, and a plurality of sheaves are arranged in the width direction (lateral direction).

The upper spreader 19 is disposed in front of the lower spreader 18 at a predetermined interval. The upper spreader 19 is connected via a pair of right and left guy lines 20 to the distal end of the boom 13. The upper spreader 19 includes an upper sheave block not shown, and a plurality of sheaves are arranged in the width direction (lateral direction).

The pair of right and left guy lines 20 are arranged at intervals in the right and left direction orthogonal to the paper surface of FIG. 1. The rear end of the guy line 20 is connected to the upper spreader 19, and the front end of the guy line 20 is connected to the distal end of the boom 13. The guy line 20 includes a guy link (metal plate), a guy rope, a guy wire (metal wire), etc.

The boom derricking rope 21 is drawn out from the boom derricking winch 22, hung on a mast distal sheave 14T at the distal end of the HL mast 14, and then hung a plurality of times between the lower sheave block of the lower spreader 18 and the upper sheave block of the upper spreader 19. The tip of the boom derricking rope 21 after being wound around the lower sheave block and the upper sheave block is fixed to the distal end of the HL mast 14.

The boom derricking winch 22 is mounted on the base end side proximal end) of the HL mast 14. The boom derricking winch 22 derricks the boom 13 while changing the distance between the lower sheave block of the lower spreader 18 and the upper sheave block of the upper spreader 19 by winding and feeding the boom derricking rope 21 and rotating the boom 13 relatively to the HL mast 14. The boom derricking winch 22 may be mounted on the turning body 11.

Further, the crane 10 includes a pair of right and left mast guy links 23 (mast guy lines), mast derricking rope 24, and a mast derricking winch 25.

A pair of right and left mast guy links 23 connect a mast distal end of the HL mast 14 and the distal end of the box mast 15. This connection links the rotation of the HL mast 14 with the rotation of the box mast 15. The pair of right and left mast guy links 23 are disposed inside the pair of right and left weight cylinders 361 described later in the right and left direction, respectively. The pair of right and left mast guy links 23 connect the mast distal end of the HL mast 14 and the turning body 11 through the mast derricking rope 24, thereby holding the HL mast 14 in the backward tilting posture shown in FIG. 1.

The mast derricking rope 24 is wound a plurality of times between a sheave block 26 arranged on a turning body 11 and having a plurality of sheaves arranged in the width direction and a sheave block 27 arranged at the distal end of the box mast 15 and having a plurality of sheaves arranged in the width direction.

The mast derricking winch 25 is arranged on the turning body 11. The mast derricking winch 25 winds and feeds the mast derricking rope 24. By the winding and feeding operation of the mast derricking rope 24 by the mast derricking winch 25, the distance between the sheave block 27 at the distal end of the box mast 15 and the sheave block 26 at the rear end of the turning body 11 is changed, and the HL mast 14 is derricked while the box mast 15 and the HL mast 14 are integrally rotated with respect to the turning body 11. The rotation of the HL mast 14 and the box mast 15 is mainly performed when the crane 10 is assembled and disassembled, and when the crane 10 is used, the positions (ground angle) of the HL mast 14 and the box mast 15 are substantially fixed.

The crane 10 is mounted with, in addition to the mast derricking winch 25 and the boom derricking winch 22, a main winding winch 30 and an auxiliary winding winch 31 for hoisting and lowering a load. In the crane 10 according to the present embodiment, both the main winding winch 30 and the auxiliary winding winch 31 are installed on the turning body 11. The winches 30, 31 of the crane 10 may be mounted on the base end of the boom 13. As shown in FIG. 1, an idler 30S for main winding and an idler 31S for auxiliary winding are disposed at the base end portion of the HL mast 14. The idler 30S for main winding and the idler 31S for auxiliary winding are respectively provided with rotatable sheaves.

The main winding winch 30 carries out hoisting and lowering of the load by the main winding rope 32 (FIG. 1). In the main winding, the boom guide sheaves 131 and 132 are rotatably provided at the distal end of the boom 13, and a sheave block for main winding in which a plurality of point sheaves for main winding are arranged in the width direction is provided at a position adjacent to the boom guide sheave 132. A main winding rope 32 suspended from the sheave block for main winding is connected to a main hook 34 for suspended load. Then, the main winding rope 32 drawn out from the main winding winch 30 is successively hung on the boom guide sheaves 130, 131, 132, and is hung between the sheave of the main winding sheave block and the sheaves of the sheave block provided on the main hook 34. Accordingly, when the main winding winch 30 winds or feeds the main winding rope 32, the main hook 34 is wound or lowered.

Similarly, the auxiliary winding winch 31 carries out hoisting and lowering of the load by the auxiliary winding rope 33. The auxiliary winding has a structure (not shown) similar to that of the main winding. When the auxiliary winding winch 31 winds or feeds the auxiliary winding rope 33, an auxiliary hook for hoisting a load (not shown) connected to the end of the auxiliary winding rope 33 is wound or lowered.

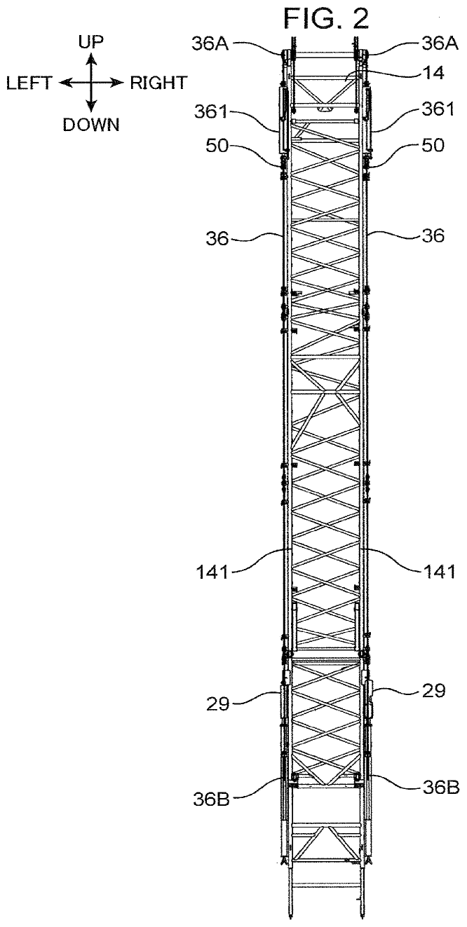

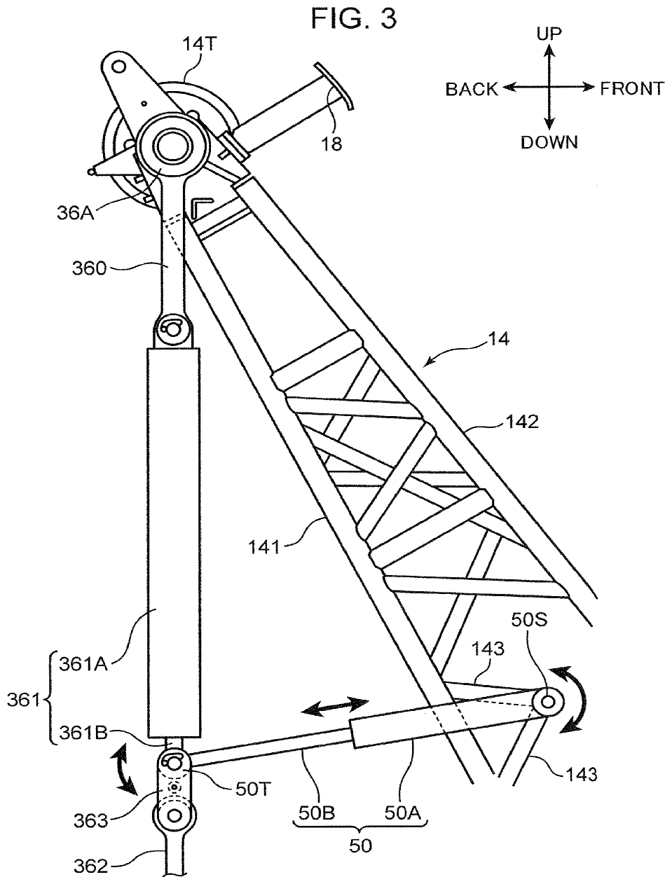

FIG. 2 is a rear view of an HL mast 14, a pair of right and left weight cylinders 361, and a pair of right and left weight guy links 36 of the crane 10 according to the present embodiment. FIG. 3 is an enlarged side view of the periphery of the mast distal end of the HL mast 14 and the weight cylinder 361, and the connecting cylinder 50 of the crane 10 according to the present embodiment. The crane 10 further includes a pair of right and left upper end links 360 (FIG. 3), a pair of hydraulic right and left weight cylinders 361 (FIG. 1), a pair of right and left weight guy links 36 (weight guy line), and a pallet weight 37 (weight).

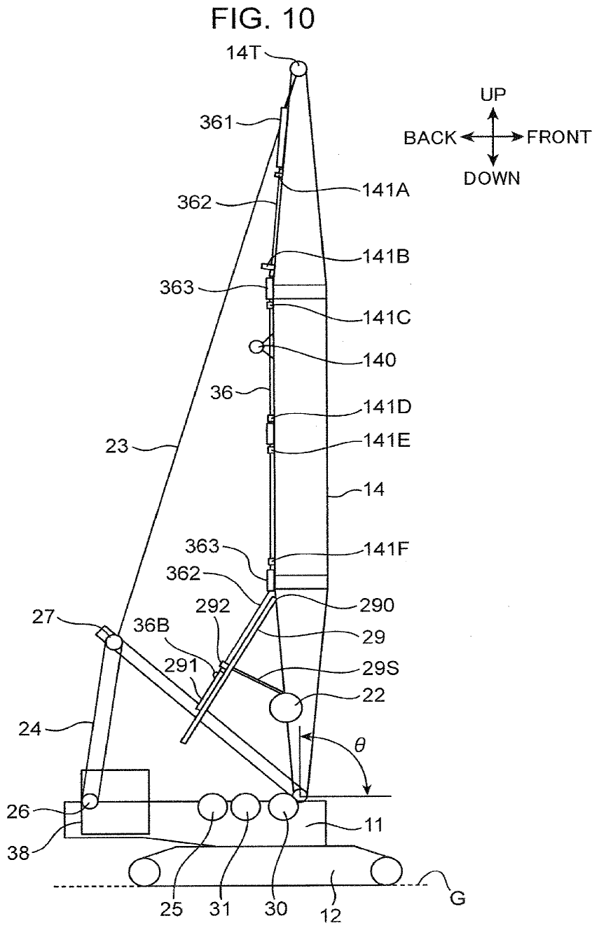

The pallet weight 37 is arranged behind the turning body 11 to maintain the balance of the crane 10. The pallet weight 37 is constituted by vertically stacking plate-like weights (weights). The pallet weight 37 has a function of keeping the balance of the crane 10 as a weight for SHL (Super Heavy Lifting) provided for lifting a heavy object by the crane 10. The pallet weights 37 are connected through a pair of right and left upper end links 360, a pair of right and left weight cylinders 361, and a pair of right and left weight guy links 36 (weight guy line) to a mast distal end of the HL mast 14. As shown in FIG. 10, the counter weight 38 may be attached to the rear portion of the turning body 11.

The upper end link 360 is suspended from the mast distal end of the HL mast 14 and connected to the weight cylinder 361. The upper end link 360 has an upper end fulcrum portion 36A. The upper end fulcrum portion 36A is rotatably supported on the mast distal end of the HL mast 14 around a horizontal rotation axis. As shown in FIG. 3, the rotation axis of the upper end fulcrum portion 36A and the rotation axis of the mast distal sheave 14T are arranged on the same axis.

A pair of right and left weight cylinders 361 are suspended through upper end links 360 from the mast distal end of the HL mast 14. Each of the pair of right and left weight cylinders 361 is expandable and contractible in a cylinder expanding and contracting direction parallel to the direction in which the weight cylinders are suspended, and has a cylinder body 361A and a cylinder rod 361B (FIG. 3).

The cylinder body 361A is composed of a cylindrical member connected to a mast distal end of the HL mast 14. A cylindrical internal space is formed inside the cylinder body 361A, and the internal space is partitioned into 2 oil chambers by a piston (not shown). The piston can be displaced in the cylinder expanding and contracting direction in the cylinder body 361A.

The cylinder rod 361B extends downward from the cylinder body 361A and is connected to the cylinder body 361A so as to be relatively displaced in the cylinder expanding and contracting direction with respect to the cylinder body 361A. Specifically, the cylinder rod 361B is connected to the piston disposed in the cylinder body 361A. When the hydraulic oil is supplied to and discharged from the 2 oil chambers partitioned by the piston, the piston is displaced, and the cylinder rod 361B is displaced relative to the cylinder body 361A in the cylinder expanding and contracting direction. As shown in FIG. 1, with the lower end portion 36B of the weight guy link 36 connected to the pallet weight 37, when the cylinder rod 361B is relatively displaced upward relative to the cylinder body 361A, that is, when the entire weight cylinder 361 is contracted, the pallet weight 37 is separated upward from the ground. As a result, the balance in the front and back direction of the crane 10 is maintained.

The pair of right and left weight guy links 36 (FIG. 1) has a plurality of line portions 362 and a plurality f link portions 363. The plurality of link portions 363 connect the plurality of line portions 362 to each other so that the plurality of line portions 362 can rotate around an axis extending in parallel with the rotation axis (mast rotation axis) of the HL mast 14. Therefore, in a plane orthogonal to the rotation axis of the HL mast 14, the weight guy link 36 can be bent with each link portion 363 as a fulcrum.

Out of the plurality of link portions 363, the link portion 363 (FIG. 3) located at the uppermost position is connected to the cylinder rod 361B of the weight cylinder 361 as a guy line upper end portion. The lower end portions 36B (guy line lower end, FIG. 1, FIG. 2) of the pair of right and left weight guy links 36 are connected to the pallet weights 37, respectively. A lower end portion 36B of the pair of right and left weight guy links 36 is provided with 1 unillustrated plate portion (male shaped portion), and an upper surface portion of the pallet weight 37 is provided with 2 unillustrated plate portions (female shaped portions). Each of the plate portions is formed of a hole portion opened in a horizontal direction, and when the male-shaped portion is inserted between the 2 female-shaped portions and then the hole portion of the male-shaped portion is matched with the hole portions of the female-shaped portion and a connection pin (not shown) is inserted into both the hole portions, a pair of right and left weight guy links 36 are connected to the pallet weight 37.

In the backward tilting posture of the HL mast 14, the pair of right and left weight guy links 36 are suspended from the pair of right and left weight cylinders 361 so as to be respectively arranged on a pair of planes orthogonally crossing the rotation axis of the HL mast 14 and passing through the pair of right and left mast backstops 29 (FIG. 2).

### <Rotation of the Cylinder Rod 361B>

As described above, each of the pair of right and left weight guy links 36 includes a plurality of line portions 362 and a plurality of link portions 363. The plurality of link portions 363 rotatably couple the line portions 362 to each other around an axis parallel to the rotation axis (mast rotation axis) of the HL mast 14. On the other hand, as described above, the 1 plate-shaped portion (male shaped portion) disposed at the lower end portion 36B of the weight guy link 36 is connected to the 2 plate-shaped portions (female shaped portions) of the pallet weight 37 in a posture in which 1 plate-shaped portion is disposed to extend in the vertical direction and in the front and back direction. In other words, in order to connect the weight guy link 36 and the pallet weight 37, the lower end portion 36B of the weight guy link 36 must be arranged along a predetermined direction. Therefore, when the cylinder rod 361B connected to the weight guy link 36 via the link portion 363 (FIG. 3) located at the uppermost position of the weight guy link 36 rotates with respect to the cylinder body 361A, the connection between the weight guy link 36 and the pallet weight 37 becomes difficult or takes time. Further, when the weight guy link 36 is connected to the pallet weight 37 and the pallet weight 37 is separated upward from the ground and the cylinder rod 361B is rotated with respect to the cylinder body 361A, the weight guy link 36 is twisted and the posture of the pallet weight 37 tends to be unstable. Therefore, a mechanism is required to prevent rotation of the cylinder rod 361B with respect to the cylinder body 361A.

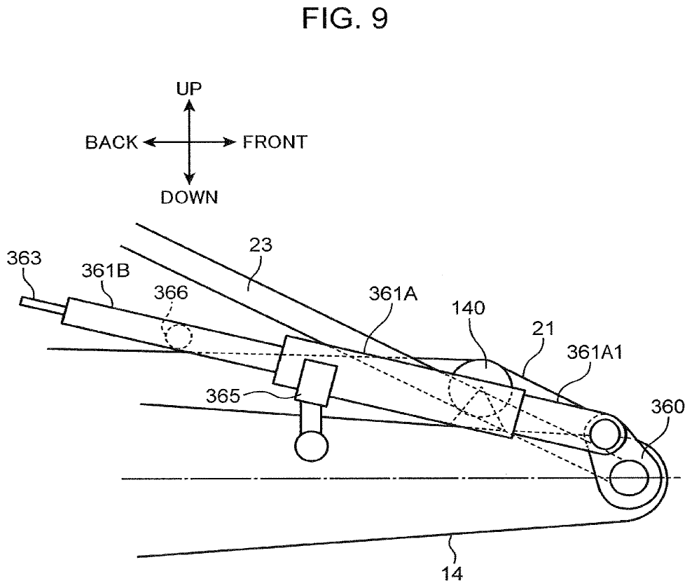

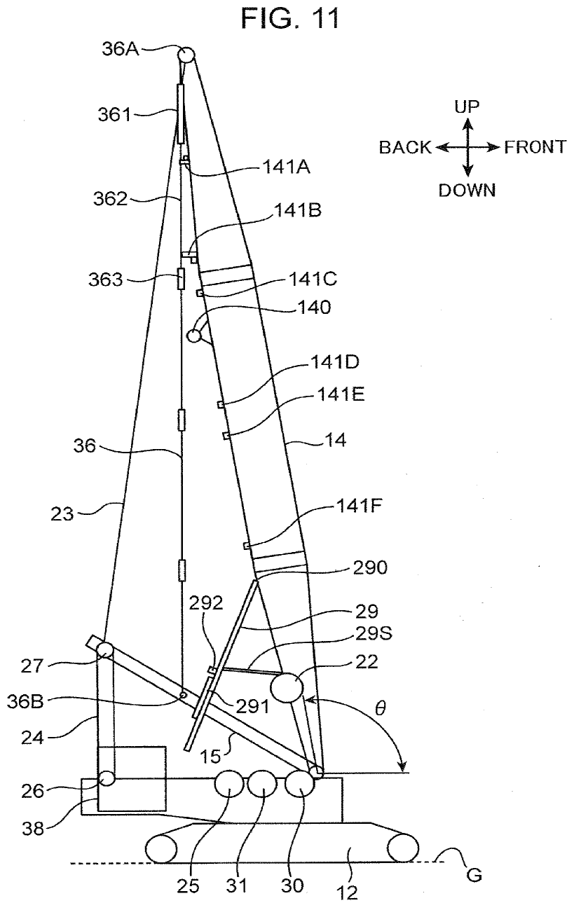

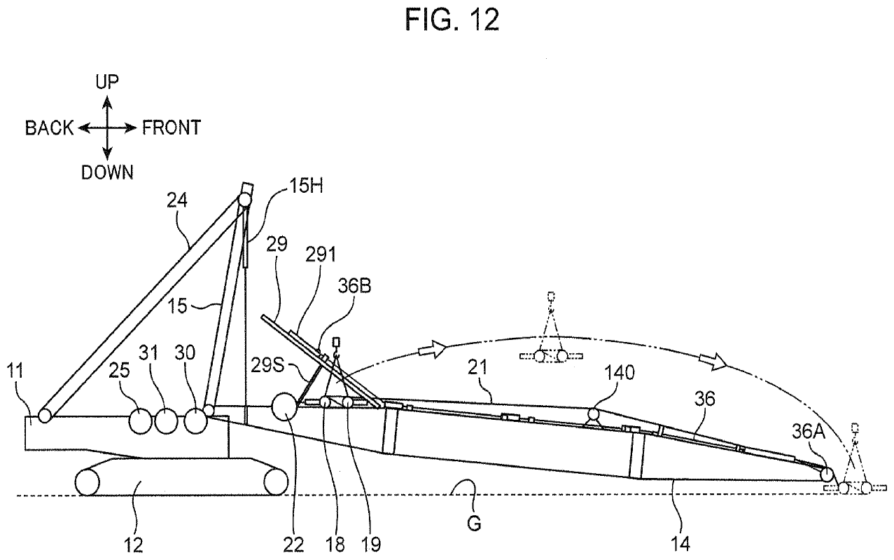

Here, FIG. 9 is an enlarged side view of the mast distal end of the HL mast 14 of the other crane compared with the crane 10 according to the present embodiment, and the periphery of the weight cylinder 361 and a rod connecting portion 366. FIGS. 10 and 11 are side views showing how the I IL mast 14 of the crane shown in FIGS. 1 and 9 is rotated with respect to the turning body 11. FIG. 12 is a side view showing a state in which the HL mast 14 of the crane shown in FIGS. 1 and 9 is laid down (falling posture). FIG. 9 shows the distal end of the HL mast 14 in a state in which the HL mast 14 is tilted forward with respect to the turning body 11. The other crane shown in FIG. 9 is different from the crane 10 of the present embodiment shown in FIG. 1 mainly in that it does not have a pair of right and left connecting cylinders 50 (FIG. 3) but has the rod connecting portion 366 (FIG. 9). More specifically, like the crane 10 according to the present embodiment, the crane includes an HL mast 14, an upper end link 360, a pair of right and left weight cylinders including a cylinder body 361A and a cylinder rod 361B, a mast idler sheave 140, a boom derricking rope 21, a pair of right and left mast guy links 23, a pair of right and left cylinder receiving portions 365, and the rod connecting portion 366.

The upper end link 360 is rotatably connected to the mast distal end of the HL mast 14, and is rotatably connected to a cylinder body link portion 361A1 arranged at an end part of the cylinder body 361A. The cylinder rod 361B is expandable and retractible with respect to the cylinder body 361A, and the cylinder rod 361B is connected to a link portion 363 in the same way as a weight guy link 36 in FIG. 1. Further, in the falling posture of the HL mast 14 as shown in FIG. 9, the pair of right and left cylinder receiving portions 365 respectively support the cylinder body 361A. The cylinder receiving portion 365 has a U-shaped distal end and receives the outer peripheral part of the cylinder body 361A. The rod connecting portion 366 is a rod-like member for connecting the pair of right and left cylinder rods 361B to each other in the right and left direction.

Referring to FIG. 9, a pair of right and left mast guy links 23 are disposed between a pair of right and left weight cylinders 361 in the right and left direction orthogonal to the paper surface of FIG. 9. Further, between the pair of right and left mast guy links 23, that is, at the center in the right and left direction of the HL mast 14, the mast idler sheave 140 is rotatably supported by the HL mast 14. The boom derricking rope 21 is drawn from the boom derricking winch 22 (FIG. 1), hung on the circumferential surface of the mast idler sheave 140, and then extended further forward in FIG. 9.

In the assembling stage of the crane shown in FIGS. 9 to 11, as shown in FIG. 12, the base end of the HL mast 14 is suspended by an auxiliary cylinder 15H suspended from the distal end of the box mast 15, and is mounted on the turning body 11. At this time, the base end of the HL mast 14 is previously mounted with a lower spreader 18 and an upper spreader 19. The sheave blocks of the lower spreader 18 and the upper spreader 19 are hooked with a boom derricking rope 21 drawn from the boom derricking winch 22. As shown in FIG. 12, after the lower spreader 18 and the upper spreader 19 are lifted by an auxiliary crane (not shown), they are moved from the base end of the HL mast 14 to the distal end of the HL mast 14 (front end of FIG. 12). At this time, the boom derricking rope 21 drawn out from the boom derricking winch 22 and wound on the lower spreader 18 and the upper spreader 19 is extended forward and hung on the peripheral surface of the mast idler sheave 140.

In the other crane shown in FIG. 9, the pair of right and left cylinder rods 361B are connected to each other by a rod connecting portion 366. Therefore, as shown in FIG. 12, in the process in which the lower spreader 18 and the upper spreader 19 move forward and the boom derricking rope 21 is extended from the boom derricking winch 22, there is a problem that the boom derricking rope 21 interferes with the rod connecting portion 366. Therefore, when the boom derricking rope 21 is extended, the rod connecting portion 366 needs to be temporarily detached from the pair of right and left cylinder rods 361B or the rod connecting portion 366 needs to be separatable at the center portion in the right and left direction. By providing such an attachable/detachable or separatable structure, as shown in FIG. 9, it is possible to extend the boom derricking rope 21 so that the boom derricking rope 21 passes under the rod connecting portion 366. However, in the other cranes shown in FIG. 9, there is a problem that the attachable/detachable structure and the separatable structure of the rod connecting portion 366 with respect to the cylinder rod 361B become complicated.

Further, as shown in FIG. 12, in a state where the HL mast 14 is supported by the turning body 11, after the distal end of the box mast 15 and the distal end of the HL mast 14 are connected by the mast guy link 23 (FIGS. 9, 10), when the mast derricking winch 25 carries out the hoisting operation of the mast derricking rope 24 so that the ground angle θ of the HL mast 14 becomes large, as shown in FIG. 10, the HL mast 14 is placed in an standing posture. The weight guy link 36 is fitted into a first receiving portion 141A, a second receiving portion 141B, a third receiving portion 141C, a fourth receiving portion 141D, a fifth receiving portion 141E, and a sixth receiving portion 141F previously provided in the rear surface portion of the HL mast 14, and the lower end portion of the weight guy link 36 is fitted into backstop receiving portions 291 and 292 provided in the mast backstop 29. As shown in FIG. 10, when the HL mast 14 extends in the vertical direction and the mast derricking winch 25 further winds up the mast derricking rope 24, the HL mast 14 is positioned as shown in FIG. 11. At this time, the weight guy link 36 is detached rearward from the first receiving portion 141A to the sixth receiving portion 141F and the backstop receiving portions 291 and 292, and is suspended from the distal end of the HL mast 14 so as to extend along the vertical direction by its own weight. When the mast derricking winch 25 further winds up the mast derricking rope 24 from the posture shown in FIG. 11, the HL mast 14 is inclined backward as shown in FIG. 1.

When the posture of the HL mast 14 is changed from the posture shown in FIG. 11 to the posture shown in FIG. 1, the weight guy link 36 connected to the weight cylinder 361 rotates rearward with the distal end of the HL mast 14 as a fulcrum so as to overtake the mast guy link 23. At this time, if the pair of right and left cylinder rods 361B are connected to each other by the rod connecting portion 366 like the other cranes shown in FIG. 9, there is a problem that the rod connecting portion 366 interferes with the pair of right and left mast guy links 23 when the HL mast 14 is rotated. The interference also becomes a problem when the HL mast 14 is rotated forward from the backward tilting posture shown in FIG. 1.

As described above, in order to solve the problem of interference between the rod connecting portion 366 (FIG. 9) connecting the pair of right and left cylinder bodies 361A of the other crane shown in FIG. 9 and the other member (mast guy link 23, boom derricking rope 21), in this embodiment, the crane 10 is provided with the pair of right and left connecting cylinders 50 (mast cylinder connoting portion) (FIG. 3). The pair of right and left connecting cylinders 50 respectively connect the HL mast 14 and the pair of right and left cylinder rods 361B so as to restrict relative rotation of the cylinder rod 361B with respect to the cylinder body 361A about the center axis of the cylinder body 361A, that is, about an axis extending in the vertical direction, while permitting expansion and contraction of the weight cylinder 361 at positions on both right and left sides of the HL mast 14 and closer to the mast base end than the mast distal end of the HL mast 14, specifically permitting relative displacement of the cylinder rod 361B with respect to the cylinder body 361A in the cylinder expanding and contracting direction.

Referring to FIG. 3, the HL mast 14 according to the present embodiment includes a pair of right and left first main pipes 141, a pair of right and left second main pipes 142, and a plurality of lattice pipes 143 for connecting the first main pipe 141 and the second main pipe 142. The first main pipes 141 are also connected to each other by lattice pipes (not shown). And the second main pipes 142 are also connected to each other by lattice pipes (not shown). The connecting cylinder 50 is expandable and contractible in an allowable expansion and contraction direction so as to allow relative displacement of the cylinder rod 361B in the cylinder expansion and contraction direction with respect to the cylinder body 361A, and has a cylindrical connecting cylinder body 50A and a connecting cylinder rod 50B. The connecting cylinder body 50A includes an internal space for receiving a connecting cylinder rod 50B, and a mast side fulcrum portion 50S. The mast side fulcrum portions 50S are arranged at one end of the connecting cylinder body 50A, and are connected to right and left sides (intersection of a pair of lattice pipes 143) of the HL mast 14 so as to be rotatable about a first rotation connecting axis parallel to the rotation axis (mast rotation axis) of the HL mast 14. On the other hand, the connecting cylinder rod 50B is connected to the connecting cylinder body 50A so as to be relatively displaceable in the allowable expanding and contracting direction with respect to the connecting cylinder body 50A. The connecting cylinder rod 50B has a guy link side fulcrum portion 50T. The guy link side fulcrum portion 50T is arranged at one end part of the connecting cylinder rod 50B, and is rotatably connected to the cylinder rod 361B about a second rotation connecting axis parallel to the mast rotation axis. The allowable expanding and contracting direction is a direction parallel to a straight line connecting the first rotation connecting axis and the second rotation connecting axis which are a pair of rotation connecting axes with each other. The connecting cylinder rod 50B may be arranged to be connected to the HL mast 14, and the connecting cylinder body 50A may be arranged to be connected to the cylinder rod 361B.

As described above, in the present embodiment, with the crane 10 in the working posture shown in FIG. 1, the cylinder rods 361B of the right and left weight cylinders 361 are connected to the HL mast 14 by the connecting cylinders 50, respectively. This prevents each of the cylinder rod 361B from rotating about its central axis, that is, about an axis extending in the vertical direction with respect to the cylinder body 361A. For connection between the weight guy links 36 and the pallet weight 37, when an operator controls a hydraulic circuit (not shown) to displace each of the cylinder rod 361B relative to the cylinder body 361A in the cylinder extending direction, the guy link side fulcrum portion 50T of the connecting cylinder 50 rotates with respect to the cylinder rod 361B, and the mast side fulcrum portion 50S rotates with respect to the HL mast 14. Therefore, the connecting cylinder 50 is prevented from hindering the expanding and contracting operation of the weight cylinder 361. As a result, in a state where the relative rotation of the cylinder rod 361B with respect to the cylinder body 361A is suppressed, the operator can easily connect the lower end portion 36B of the weight guy link 36 to the pallet weight 37. Furthermore, in this embodiment, after the pallet weight 37 and the lower end porton 36B of the weight guy link 36 are connected to each other, the twisting of the weight guy link 36 by the rotation of the cylinder rod 361B is suppressed.

When the crane 10 is disassembled, after the lower end portion 36B of the weight guy link 36 is detached from the pallet weight 37, the boom 13 is fallen forward from the state shown in FIG. 1, and the HL mast 14 is further fallen forward. At this time, the weight guy link 36 moves forward following the HL mast 14 in an posture extending in the vertical direction by its own weight (See FIGS. 10 and 11). As shown in FIG. 10, when the HL mast 14 is in an posture extending in the vertical direction, the weight guy link 36 is stored in the first receiving portion 141A to the sixth receiving portion 141F and the backstop receiving portions 291 and 292. As described above, since the mast side fulcrum portion 50S and the guy link side fulcrum portion 50T of the connecting cylinder 50 are rotatable with respect to the HL mast 14 and the cylinder rod 361B, respectively, the movement of the weight guy link 36 as described above is easily realized.

Further, in the present embodiment, when the crane 10 is viewed in the right and left direction with the HL mast 14 in the backward tilting posture (FIG. 1), the mast guy link 23 is disposed below the connecting cylinder 50 (FIG. 3) between the HL mast 14 and the weight guy link 36 in the front and back direction. The posture of the HL mast 14 can be changed between the backward tilting posture and the falling posture, and the falling posture is such that the HL mast 14 in the backward tilting posture is rotated forward with the mast base end (HL mast foot 14S) as a fulcrum and further rotated forward through a posture extending along the vertical direction (FIG. 10). The pair of right and left weight guy links 36 provided in the crane 10 are arranged on both outer sides of the pair of right and left mast guy links 23 in the right and left direction. When the posture of the HL mast 14 is changed from the posture shown in FIG. 1 to the falling posture shown in FIG. 12 through the posture shown in FIG. 10, the rotation ranges of the weight guy link 36 and the mast guy link 23 around the mast distal end are set so that the weight guy link 36 overtakes the mast guy link 23 below the connecting cylinder 50 (FIG. 11). Even in such a case, the pair of right and left cylinder rods 361B are connected to the HL mast 14 by the pair of right and left connecting cylinders 50, respectively, and no connecting member such as the rod connecting portion 366 of FIG. 9 is disposed between the pair of right and left cylinder rods 361B. Therefore, even when the HL mast 14 changes its posture (rotating) such that the weight guy link 36 overtakes the mast guy link 23 when viewed from the right and left direction, the weight guy link 36 and the mast guy link 23 do not interfere with each other. In other words, in the present embodiment, the pair of right and left connecting cylinders 50 respectively connect the pair of right and left weight cylinders 361 and the HL mast 14 so that other members are disposed in a space between the pair of right and left weight cylinders 361 or so as to allow the other members to pass through the space. Further, as shown in FIG. 3, the expansion and contraction of the connecting cylinder 50 in the allowable expansion and contraction direction, i.e., the relative displacement of the connecting cylinder rod 50B in the allowable expansion and contraction direction with respect to the connecting cylinder body 50A, allows the weight cylinder 361 to be easily moved toward the HL mast 14 when the HL mast 14 is rotated from the posture shown in FIG. 1 to the posture shown in FIG. 10.

In the present embodiment, as shown in FIG. 1, when the crane 10 is viewed in the left ad right direction with the HL mast 14 in the backward tilting posture, the boom derricking rope 21 is stretched below the connecting cylinder 50 (FIG. 3) between the boom derricking winch 22 and the mast idler sheave 140 (mast distal sheave 14 T) so as to he positioned between the weight guy link 36 and the HL mast 14. That is, in the working posture of the crane 10, the cylinder rod 361B is disposed at a position farther than the mast guy link 23 when viewed from the HL mast 14. The cylinder rods 361B are connected to the HL mast 14 by a pair of right and left connecting cylinders 50. Therefore, in the falling posture of the HL mast 14 as shown in FIG. 12, when the boom derricking rope 21 is hung by the auxiliary crane between the base end portion and the distal end portion of the HL mast 14 through the space above the HL mast 14, the interference of the boom derricking rope 21 with the pair of right and left weight cylinders 361 is suppressed. As a result, compared with the case in which the pair of right and left cylinder rods 361B are connected to each other by the rod connecting portion 366 shown in FIG. 9, the work of extending the boom derricking rope 21 (lifting and moving work of the lower spreader 18 and the upper spreader 19) can be realized in a short time.

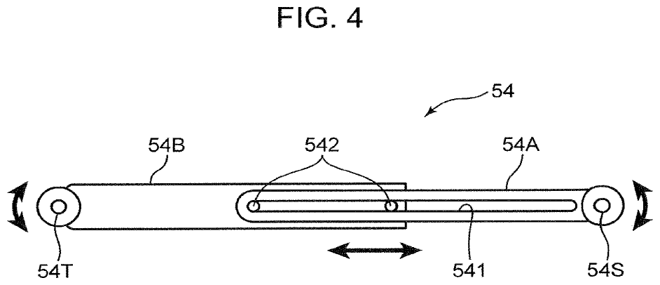

Next, a crane according to a second embodiment of the present invention will be described. FIG. 4 is a side view of the connecting slide mechanism 54 of the crane according to the present embodiment. In this embodiment, instead of the connecting cylinder 50 of FIG. 3, the crane includes a connecting slide mechanism 54 (mast cylinder connecting portion). The connecting slide mechanism 54 has a first slide member 54A (first slide connecting portion) and a second slide member 54B (second slide connecting portion). The first slide member 54A includes a mast side fulcrum portion 54S rotatably connected to the HL mast 14 (FIG. 3) about a rotation axis parallel to the mast rotation axis. The first slide member 54A is formed of an elongated guide hole 541. On the other hand, the second slide member 54B includes a guy link side fulcrum portion 54T rotatably connected to the cylinder rod 361B about a rotation axis parallel to the mast rotation axis. Further, the second slide member 54B has a pair of guide pins 542. The pair of guide pins 542 are fitted into the guide hole 541. As a result, the second slide member 54B is connected to the first slide member 54A so as to be relatively slidable in the allowable expanding and contracting direction. This slide allows the entire connecting slide mechanism 54 to expand and contract in the allowable expanding and contracting direction. Even in such a configuration, the same effect as in the first embodiment can be obtained. Further, according to the present embodiment, compared with the connecting cylinder 50 according to the first embodiment, the connecting slide mechanism 54 can be made lighter, and power for driving the connecting slide mechanism 54 is not required.

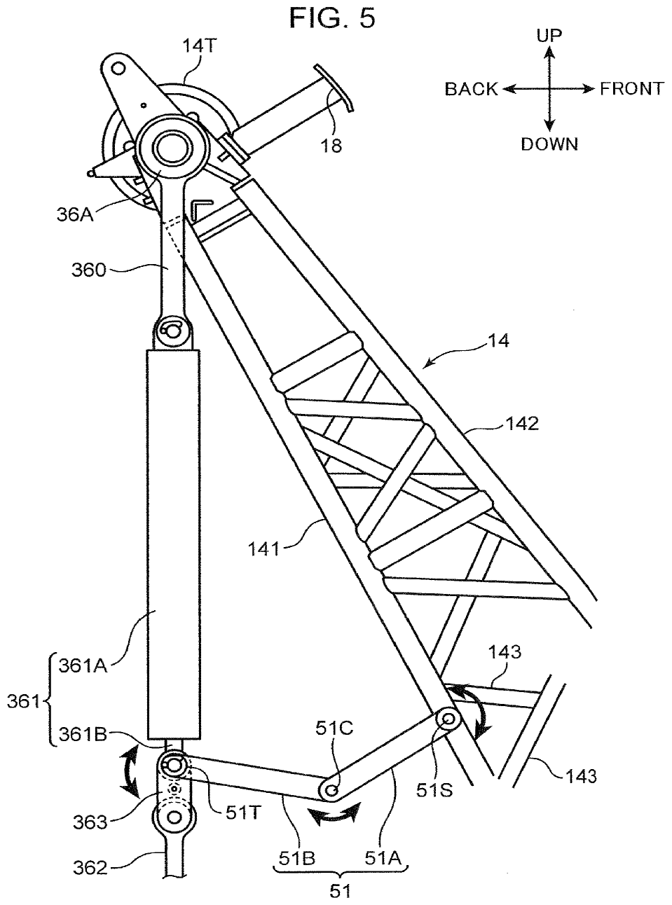

Next, a crane according to a third embodiment of the present invention will be described. FIG. 5 is an enlarged perspective view of the mast distal end of the HL mast 14 of the crane according to the present embodiment, and the periphery of the weight cylinder 361 and the connecting link mechanism 51. In this embodiment, instead of the connecting cylinder 50 of FIG. 3, the crane includes a connecting link mechanism 51 (mast cylinder connecting portion). The connecting link mechanism 51 has a first link 51A (first link portion) and a second link 51B (second link portion). The first link 51A has a mast side fulcrum portion 51S. The mast side fulcrum portion 51S is rotatably connected to a first main pipe 141 of the HL mast 14 about a first rotation connecting axis parallel to the mast rotation axis. On the other hand, the second link 51B has a guy link side fulcrum portion 51T. The guy link side fulcrum portion 51T is rotatably connected to the cylinder rod 361B about a second rotation connecting axis parallel to the mast rotation axis. Further, the second link 51B is connected to the first link 51A at the link fulcrum 51C so as to be rotatable about a link rotation axis parallel to the mast rotation axis. The rotation of the second link 51B about the link rotation axis with respect to the first link 51A enables the entire connecting link mechanism 51 to expand and contract in the allowable expanding and contracting direction (a direction parallel to a straight line connecting a pair of the first and second rotation connecting axes, as a pair of rotation connecting axes, to each other).

As described above, also in this embodiment, the connecting link mechanism 51 connects the cylinder rod 361B and the HL mast 14 to each other. Therefore, rotation of the cylinder rod 361B about an axis extending in the vertical direction with respect to the cylinder body 361A is suppressed, and the connecting link mechanism 51 is prevented from hindering the expansion/contraction operation of the cylinder rod 361B. As a result, the operator can easily connect the lower end portion 36B of the weight guy link 36 with the pallet weight 37 in a state where the rotation of the cylinder rod 361B is suppressed. In the rotating operation of the HL mast 14 and the hanging operation of the boom derricking rope 21 on the HL mast 14, interference of the mast guy link 23, the boom derricking rope 21 and the weight cylinder 361 is suppressed. Further, according to the present embodiment, the connecting link mechanism 51 can be further simplified in structure as compared with the second embodiment. Further, since the connecting link mechanism 51 is bendable, the weight cylinder 361 can be brought close to the HL mast 14 at the time of storing, and space saving of the HL mast 14 (crane 10) in the stored state is realized.

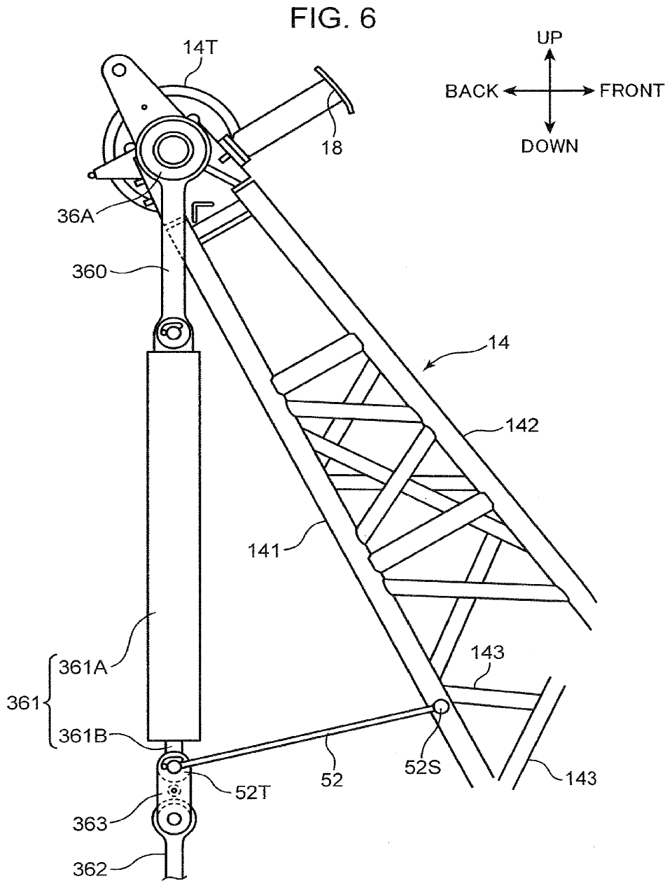

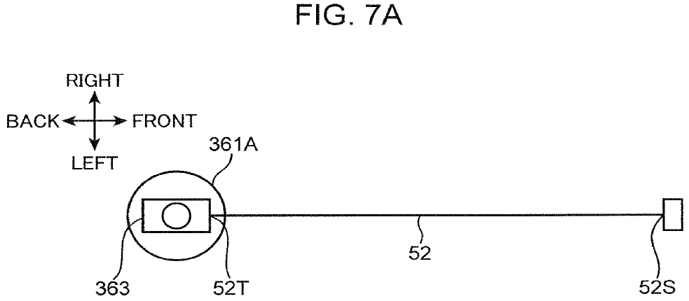

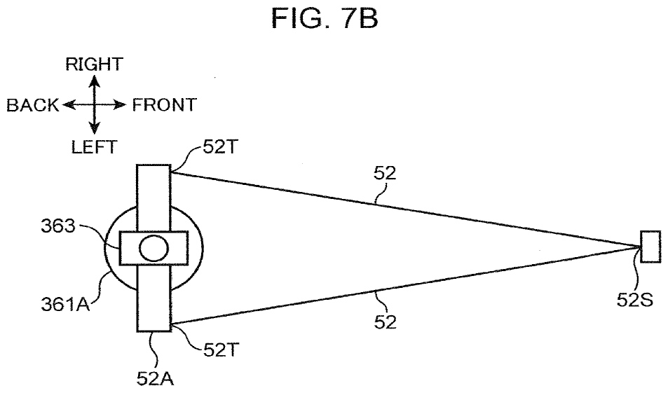

Next, a crane according to a fourth embodiment of the present invention w be described. FIG. 6 is an enlarged perspective view of the mast distal end of the HL mast 14 of the crane according to the present embodiment, and the periphery of the weight cylinder 361 and the connecting wire 52. FIGS. 7A and 7B are enlarged bottom views of the periphery of the connecting wire 52 of the crane according to the present embodiment. In this embodiment, instead of the connecting cylinder 50 of FIG. 3, the crane includes at least one connecting wire 52 (mast cylinder connecting portion, wire). As shown in FIG. 7A, one connecting wire 52 may connect the HL mast 14 and the cylinder rod 361B at the mast side fulcrum portion 52S and the guy link side fulcrum portion 52T, or as shown in FIG. 7B, two connecting wires 52 may connect the HL mast 14 and the cylinder rod 361B, respectively. In the embodiment of FIG. 7B, a support member 52A extending in the right and left direction from the link portion 363 located at the uppermost position of the weight guy link 36 is provided, and a pair of connecting wires 52 are fixed to the support member 52A. In the state shown in FIG. 7B, the two connecting wires 52 may be arranged with some slack. Even in such a configuration, the same effects as those of the first and second embodiments can be achieved. In addition, according to the present embodiment, the connecting wire 52 can have a light and simple structure as compared with the third embodiment. The connecting wire 52 may also allow right and left movement of the weight guy link 36. Furthermore, the connecting wire 52 can follow the instantaneous movement of the weight guy link 36 to suppress the rotation of the cylinder rod 361B.

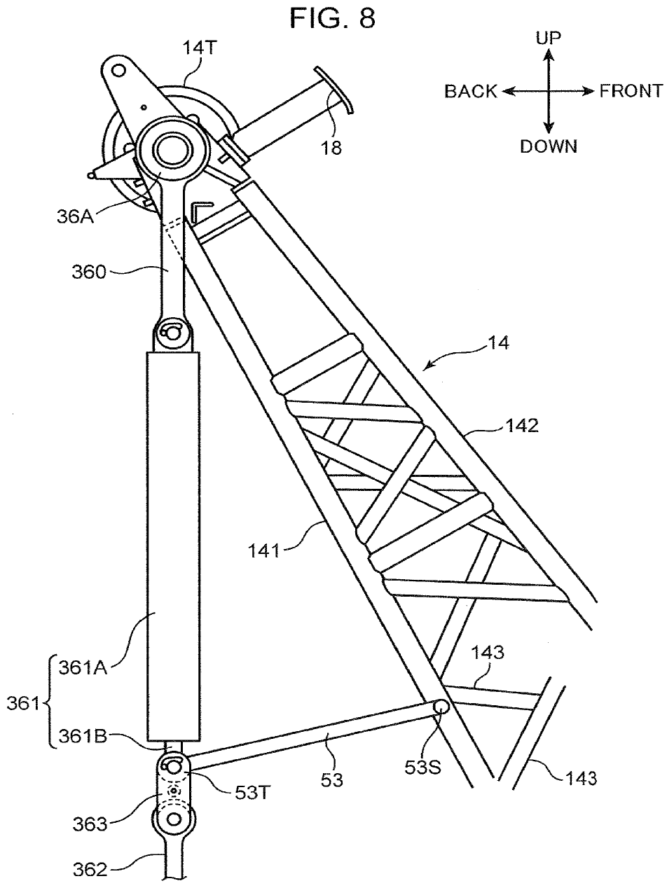

Next, a crane according to a fifth embodiment of the present invention will be described. FIG. 8 is an enlarged perspective view of the mast distal end of the FIL mast 14 of the crane according to the present embodiment, and the periphery of the weight cylinder 361 and the connecting tube 53. In this embodiment, instead of the connecting cylinder 50 of FIG. 3, the crane includes a connecting tube 53 (mast cylinder connecting portion, elastic member). The connecting tube 53 is an elastic member that connects the cylinder rod 361B and the HL mast 14 to each other and is elastically deformable so as to expand and contract in an allowable expanding and contracting direction (longitudinal direction of connecting tube 53) so as to permit expansion and contraction of the weight cylinder 361. A mast side fulcrum portion 53S of the connecting tube 53 is connected to the HL mast 14, and a guy link side fulcrum portion 53T of the connecting tube 53 is connected to a cylinder rod 361B. The connecting tube 53 can be elastically deformed according to the rotation of the weight cylinder 361 with respect to the HL mast 14 and the expanding/contracting operation of the weight cylinder 361 in the cylinder expanding/contracting direction. Even in such a configuration, the same effects as those of the first and second embodiments can be achieved. The elastic member may constitute a part of the mast cylinder connecting portion. In addition, according to this embodiment, as compared with the previous fourth embodiment, the connecting tube 53 can allow backward movement of the weight guy link 36. The connecting tube 53 has a function of pulling back the weight guy link 36 forward by restoring force without providing a special power mechanism. As a result, the positional stability of the weight guy link 36 can be improved.

The crane 10 according to each embodiment of the present invention has been described above. The present invention is not limited to these embodiments. The present invention can take, for example, the following modified embodiments.

(1) The weight guy line according to the present invention is not limited to the weight guy link 36. The weight guy line according to the present invention may be a cable, a rope, a wire or the like other than the guy link.

(2) In the above embodiment, as shown in FIG. 1, the main hook 34 is suspended from the distal end of the boom 13 via the main winding rope 32, but the present invention is not limited thereto. The present invention also includes, for example, a mode in which a jib (not shown) is rotatably supported at the distal end of a boom 13, and a main winding rope 32 and a main hook 34 are suspended from the distal end of the jib.

The present invention provides a crane including: a crane body; a boom rotatably supported on the crane body about a horizontal rotation axis; a mast having a mast base end rotatably supported on the crane body about a mast rotation axis parallel to the rotation axis of the boom at a position on the rear side of the boom, and a mast distal end opposite to the mast base end, and functioning as a support in the rotation of the boom in a backward tilting posture extending backward and upward from the crane body; a pair of right and left weight cylinders respectively suspended from both right and left ends of the mast distal end and expandable and contractible in a cylinder expanding and contracting direction parallel to the direction of the suspension, the pair of right and left weight cylinders each having a cylindrical cylinder body connected to the mast distal end and a cylinder rod extending downward from the cylinder body and connected to the cylinder body so as to be relatively displaceable in the cylinder expanding and contracting direction with respect to the cylinder body; a pair of right and left weight guy lines suspended from the cylinder rod of the weight cylinder, the pair of right and left weight guy lines each having a guy line upper end portion connected to the cylinder rod and a guy line lower end portion; a weight which is connected to the guy line lower end portions of the pair of right and left weight guy lines, respectively, and holds the balance of the crane body; and a pair of right and left mast cylinder connecting portions respectively connecting the right and left side portions of the mast and the pair of right and left cylinder rods at positions closer to the mast base end than the mast distal end so as to restrict elative rotation of the cylinder rod relative to the cylinder body about the center axis of the cylinder body while permitting relative displacement of the cylinder rod relative to the cylinder body in the cylinder expanding and contracting direction.

According to this configuration, the pair of right and left mast cylinder connecting portions individually connect the cylinder rods of the pair of right and left weight cylinders to the mast while allowing the pair of right and left weight cylinders to expand and contract in the cylinder expanding and contracting direction, respectively, thereby suppressing the cylinder rods of the pair of right and left weight cylinders from rotating relative to the cylinder body about the center axis of the cylinder body. This makes it easy to avoid interference between the weight cylinder and other members such as the connecting member when the crane is assembled and disassembled, unlike the conventional suppression of the relative rotation by interconnecting a pair of right and left cylinder rods. The suppression of the relative rotation of the cylinder rod with respect to the cylinder body facilitates the connection between the weight and the guy line lower end of the weight guy line, and suppresses the occurrence of twisting in the weight guy line in accordance with the rotation of the cylinder rod after the weight connection.

It is preferable, in the above configuration, that a pair of right and left mast guy lines for connecting the crane body and the mast distal end to each other inside the pair of right and left weight cylinders in the right and left direction to hold the mast in the backward tilting posture; the posture of the mast can be changed between the backward tilting posture and the falling posture, and the falling posture is a posture in which the mast in the backward tilting posture is rotated forward about the mast base end as a fulcrum and further rotated forward through a posture extending along the vertical direction, when the crane with the mast in the backward tilting posture is viewed along the right and left direction, the mast guy line is arranged between the mast and the weight guy line in the front and back direction below the mast cylinder connecting portion, the rotating ranges of the mast guy line and the weight guy line around the distal end of the mast are respectively set so that the weight guy line overtakes the mast guy line and approaches the mast at a position below the mast cylinder connecting portion when the posture of the mast is changed from the backward tilting posture to the falling posture with the guy line lower end portion of the weight guy line detached from the weight.

According to this constitution, when the weight cylinder rotates with respect to the mast distal end with the rotation of the mast in assembling and disassembling the crane, the mast cylinder connecting portion suppresses the interference of the weight cylinder and the mast guy line.

It is preferable, in the above configuration, that the crane may further includes: an idler sheave rotatably supported on the mast distal end between the pair of right and left weight cylinders in the right and left directions; a boom derricking winch mounted on the mast base end or the crane body; and a boom derricking rope, wherein the boom derricking rope is wound between the boom derricking winch and the idler sheave so as to be positioned between the weight guy line and the mast below the mast cylinder connecting portion when the crane with the mast in the backward tilting posture is viewed in the right and left direction.

According to this configuration, when the crane is assembled and disassembled, the interference between the weight cylinder and the boom derricking rope can be easily avoided when the boom derricking rope is stretched between the boom derricking winch and the idler sheave.

It is preferable, in the above configuration, that the mast cylinder connecting portion is rotatably connected to each of the cylinder rod and the mast about a pair of rotation connecting axes parallel to the mast rotation axis, and is expandable and contractible in an allowable expanding and contracting direction connecting the pair of rotation connecting axes so as to permit expansion and contraction of the weight cylinder in the cylinder expanding and contracting direction.

In the above configuration, it is preferable that the mast cylinder connecting portion includes: a connecting cylinder body rotatably connected to one of the cylinder rod and the mast about one of the pair of rotation connecting axes; and a connecting cylinder rod rotatably connected to the other of the cylinder rod and the mast about the other of the pair of rotation connecting axes and connected to the connecting cylinder body so as to be relatively displaceable in the allowable expanding and contracting direction with respect to the connecting cylinder body.

It is preferable, in the above configuration, that the mast cylinder connecting portion includes: a first link portion rotatably connected to one of the cylinder rod and the mast about one of the pair of rotation connecting axes; and a second link portion rotatably connected to the other of the cylinder rod and the mast about the other rotation connecting axis of the pair of rotation connecting axes and rotatably connected to the first link part about a link rotation axis parallel to the mast rotation axis, and the whole mast cylinder connecting portion is expanded and contracted in the allowable expanding and contracting direction by the rotation of the second link portion about the link rotation axis with respect to the first link portion.

In the above configuration, it is preferable that the mast cylinder connecting portion includes: a first slide connecting portion rotatably connected to one of the cylinder rod and the mast about one of the pair of rotation connecting axes; and a second slide connecting portion rotatably connected to the other of the cylinder rod and the mast about the other rotation connecting axis out of the pair of rotation connecting axes and slidably connected to the first slide connecting portion in the allowable expanding and contracting direction.

It is preferable, in the above configuration, that the mast cylinder connecting portion may include an elastic member elastically deformable so as to allow expansion and contraction of the weight cylinder. Further, the mast cylinder connecting portion may be at least one wire for connecting the cylinder rod and the mast to each other.

1. A crane comprising:
a crane main body;
a boom rotatably supported on the crane body about a horizontal rotation axis;
a mast having a mast base end rotatably supported on the crane body about a mast rotation axis parallel to the rotation axis of the boom at a position on the rear side of the boom, and a mast distal end opposite to the mast base end, and functioning as a support in the rotation of the boom in a backward tilting posture extending backward and upward from the crane body;
a pair of right and left weight cylinders respectively suspended from both right and left ends of the mast distal end and expandable and contractible in a cylinder expanding and contracting direction parallel to the direction of the suspension, the pair of right and left weight cylinders each having a cylindrical cylinder body connected to the mast distal end and a cylinder rod extending downward from the cylinder body and connected to the cylinder body so as to be relatively displaceable in the cylinder expanding and contracting direction with respect to the cylinder body;
a pair of right and left weight guy lines suspended from the cylinder rod of the weight cylinder, the pair of right and left weight guy lines each having a guy line upper end portion connected to the cylinder rod and a guy line lower end portion;
a weight which is connected to the guy line lower end portions of the pair of right and left weight guy lines, respectively, and holds the balance of the crane body; and
a pair of right and left mast cylinder connecting portions respectively connecting the right and left side portions of the mast and the pair of right and left cylinder rods at positions closer to the mast base end than the mast distal end so as to restrict relative rotation of the cylinder rod relative to the cylinder body about the center axis of the cylinder body while permitting relative displacement of the cylinder rod relative to the cylinder body in the cylinder expanding and contracting direction.

2. The crane according to claim 1, wherein
a pair of right and left mast guy lines for connecting the crane body and the mast distal end to each other inside the pair of right and left weight cylinders in the right and left direction to hold the mast in the backward tilting posture;
the posture of the mast can be changed between the backward tilting posture and the falling posture, and the falling posture is a posture in which the mast in the backward tilting posture is rotated forward about the mast base end as a fulcrum and further rotated forward through a posture extending along the vertical direction,
when the crane with the mast in the backward tilting posture is viewed along the right and left direction, the mast guy line is arranged between the mast and the weight guy line in the front and back direction below the mast cylinder connecting portion,
the rotating ranges of the mast guy line and the weight guy line around the distal end of the mast are respectively set so that the weight guy line overtakes the mast guy line and approaches the mast at a position below the mast cylinder connecting portion when the posture of the mast is changed from the backward tilting posture to the falling posture with the guy line lower end portion of the weight guy line detached from the weight.

3. The crane according to claim 1 further comprising:
an idler sheave rotatably supported on the mast distal end between the pair of right and left weight cylinders in the right and left directions;
a boom derricking winch mounted on the mast base end or the crane body; and
a boom derricking rope, wherein the boom derricking rope is wound between the boom derricking winch and the idler sheave so as to be positioned between the weight guy line and the mast below the mast cylinder connecting portion when the crane with the mast in the backward tilting posture is viewed in the right and left direction.

4. The crane according to claim 1, wherein
the mast cylinder connecting portion is rotatably connected to each of the cylinder rod and the mast about a pair of rotation connecting axes parallel to the mast rotation axis, and is expandable and contractible in an allowable expanding and contracting direction connecting the pair of rotation connecting axes so as to permit expansion and contraction of the weight cylinder in the cylinder expanding and contracting direction.

5. The crane according to claim 4, wherein
the mast cylinder connecting portion includes:
a connecting cylinder body rotatably connected to one of the cylinder rod and the mast about one of the pair of rotation connecting axes; and
a connecting cylinder rod rotatably connected to the other of the cylinder rod and the mast about the other of the pair of rotation connecting axes and connected to the connecting cylinder body so as to be relatively displaceable in the allowable expanding and contracting direction with respect to the connecting cylinder body.

6. The crane according to claim 4, wherein
the mast cylinder connecting portion includes:
a first link portion rotatably connected to one of the cylinder rod and the mast about one of the pair of rotation connecting axes; and
a second link portion rotatably connected to the other of the cylinder rod and the mast about the other rotation connecting axis of the pair of rotation connecting axes and rotatably connected to the first link part about a link rotation axis parallel to the mast rotation axis, and the whole mast cylinder connecting portion is expanded and contracted in the allowable expanding and contracting direction by the rotation of the second link portion about the link rotation axis with respect to the first link portion.

7. The crane according to claim 4, wherein
the mast cylinder connecting portion includes:
a first slide connecting portion rotatably connected to one of the cylinder rod and the mast about one of the pair of rotation connecting axes; and
a second slide connecting portion rotatably connected to the other of the cylinder rod and the mast about the other rotation connecting axis out of the pair of rotation connecting axes and slidably connected to the first slide connecting portion in the allowable expanding and contracting direction.

8. The crane according to claim 1, wherein
the mast cylinder connecting portion includes an elastic member elastically deformable so as to allow expansion and contraction of the weight cylinder.

9. The crane according to claim 1, wherein
the mast cylinder connecting portion is at least one wire for connecting the cylinder rod and the mast to each other.
